(19) United States
(12) Patent Application Publication
(10) Pub. No.: US 2016/0320221 A1
(43) Pub. Date: Nov. 3, 2016

(54) Detecting Apparatus and System for Detecting a Level of a Material in a Container

(71) Applicant: Tien-Ming Chou, Taichung City (TW)

(72) Inventor: Tien-Ming Chou, Taichung City (TW)

(21) Appl. No.: 14/843,414

(22) Filed: Sep. 2, 2015

(30) Foreign Application Priority Data
May 1, 2015 (TW) 104206714

(51) Int. Cl. G01F 23/26

(52) U.S. Cl. CPC G01F 23/263

(57) ABSTRACT

An apparatus for detecting a material in a container includes a sensor configured to be disposed at the container, and a control module coupled to the sensor. The control module is configured to: transmit a test signal to the sensor so as to enable the sensor to perform a detecting operation, to generate a response signal according to the detecting operation, and to transmit the response signal to the control module; and determine whether the container contains the material in vicinity of a location where the sensor is disposed.

### CROSS-REFERENCE TO RELATED APPLICATION

This application claims priority of Taiwanese Application No. 104206714, filed on May 1, 2015.

### FIELD

The disclosure relates to a detecting apparatus and a system for detecting a level of a material in a container.

### BACKGROUND

A conventional level inspection apparatus typically employs a mechanical structure disposed inside a container in order to obtain a level of a material contained in the container. The mechanical structure typically includes a float type gauge or a reed switch.

However, the mechanical structure is required to be placed inside the container in order to operate. When the material is in liquid form, the accumulation of foreign substances such as limescale may hinder the operation of the conventional level inspection apparatus.

### SUMMARY

Therefore, an object of the disclosure is to provide a detecting apparatus that can alleviate the drawback of the prior art.

According to the disclosure, the detecting apparatus is for detecting a material in a container, and includes a sensor configured to be disposed at the container, and a control module coupled to the sensor.

The control module is configured to:
transmit a test signal to the sensor so as to enable the sensor to perform a detecting operation, to generate a response signal according to the detecting operation, and to transmit the response signal to the control module, and
determine whether the container contains the material in vicinity of a location where the sensor is disposed.

Another object of the disclosure is to provide a material detecting system. The material detecting system includes a container for containing a material, and a detecting apparatus.

The detecting apparatus is configured for detecting the material in the container, and includes a sensor disposed at the container, and a control module coupled to the sensor. The control module is configured to:
transmit a test signal to the sensor so as to enable the sensor to perform a detecting operation, to generate a response signal according to the detecting operation, and to transmit the response signal to the control module; and
determine whether the container contains the material in vicinity of a location where the sensor is disposed.

### BRIEF DESCRIPTION OF THE DRAWINGS

Other features and advantages of the disclosure will become apparent in the following detailed description of the embodiments with reference to the accompanying drawings, of which:

FIGS. 1 and 2 illustrate a material detecting system according to a first embodiment of the disclosure;

FIG. 3 illustrates a detecting apparatus of the material detecting system, according to the first embodiment;

FIGS. 4 to 8 illustrate various implementations of the first embodiment;

FIG. 9 illustrates an alternative implementation of the first embodiment, where the components are disassembled;

FIG. 10 illustrates the alternative implementation of the first embodiment, where the components are assembled;

FIG. 11 illustrates another alternative implementation of the first embodiment;

FIG. 12 illustrate a detecting apparatus of a material detecting system, according to a second embodiment of the disclosure;

FIGS. 13 to 17 illustrate various implementations of the second embodiment;

FIG. 18 illustrates a detecting apparatus of a material detecting system according to a third embodiment, where the components are disassembled;

FIG. 19 illustrates the detecting apparatus of the third embodiment, where the components are assembled;

FIG. 20 illustrates an alternative implementation of the third embodiment, where the components are disassembled; and

FIG. 21 illustrates the alternative implementation of the third embodiment, where the components are assembled.

### DETAILED DESCRIPTION

Before the disclosure is described in greater detail, it should be noted that like elements are denoted by the same reference numerals throughout the disclosure.

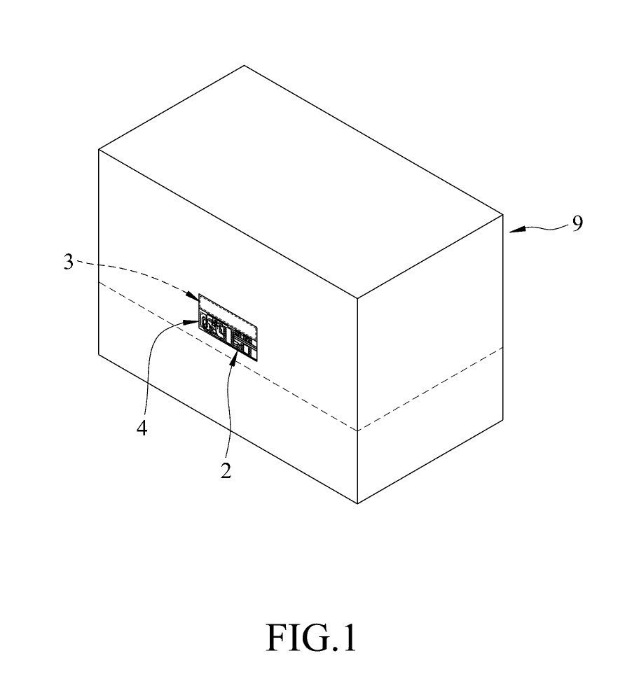

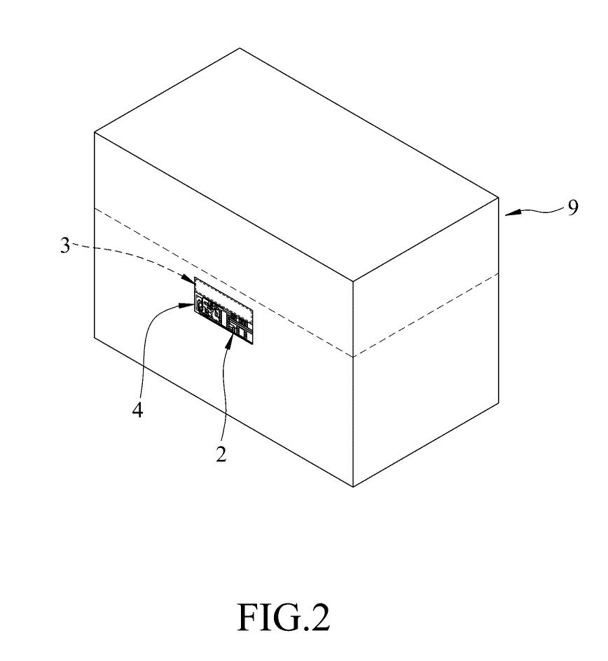

FIGS. 1 and 2 illustrate a material detecting system according to a first embodiment of the disclosure.

The material detecting system is for detecting a level of a material, and includes a container 9 for containing the material, and a detecting apparatus. In this embodiment, the material is a liquid, while in other embodiments the material detecting system may be used for detecting other materials such as a metal.

The container 9 includes a bottom, and a level of the material in the container 9 (i.e., a height from the bottom) is illustrated by a dashed line seen on the container 9.

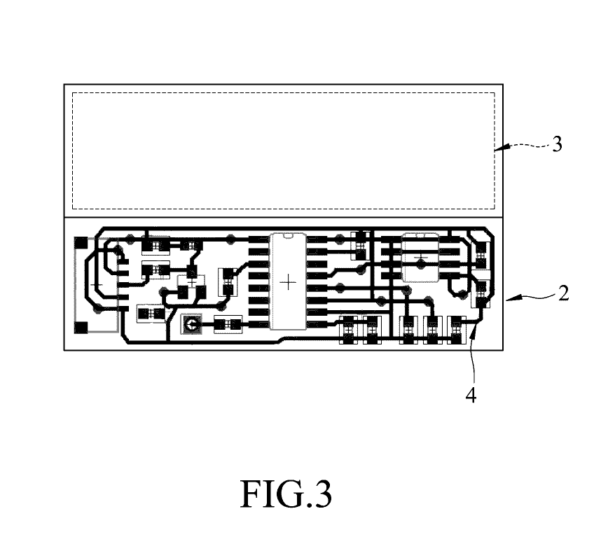

Further referring to FIG. 3, the detecting apparatus is configured for detecting the material in the container 9, and includes a substrate 2, a first sensor 3 and a control module 4. In this embodiment, the substrate 2 has two opposite surfaces, and is attached to the container 9. The first sensor 3 is disposed on one of the surfaces of the substrate 2 for being attached directly to the container 9.

In this embodiment, the first sensor 3 is made in the form of a metal plate, and may be made by a conductive material such as stainless steel, copper, iron, etc.

The control module 4 is coupled to the first sensor 3, and is disposed on the other one of the surfaces of the substrate 2 (i.e., opposite to the first sensor 3, which is illustrated in FIG. 3 by dashed lines).

In use, the detecting apparatus is attached to the container 9 at a specific height from the bottom.

When it is desired to determined whether a level of the material in the container 9 is above (or below) the specific height of the container 9, the control module 4 transmits a first test signal to the first sensor 3 so as to enable the first sensor 3 to perform a detecting operation. In response to the first test signal, the first sensor 3 is controlled to perform the detecting operation and generate a first response signal accordingly, and to transmit the first response signal to the control module 4.

In turn, the control module 4 determines whether the container 9 contains the material in vicinity of a location where the first sensor 3 is disposed.

In this embodiment, the control module 4 and the first sensor 3 cooperate as a capacitive sensor. In order to determine whether the container 9 contains the material in vicinity of the location of the first sensor 3, an initiation process may be performed. In the initiation process, the container 9 is made empty, and the first sensor 3 is controlled to detect a measured reference capacitance, which serves as the first reference signal. The control module 4 then receives the measured reference capacitance for future reference. After the initiation process is completed, the detecting apparatus may be used to detect the level of the material of the container 9.

For the container 9 in FIG. 1 (where the level of the material is lower than the position of the detecting apparatus), when the first sensor 3 is controlled to perform the detecting operation, a capacitance approximately equal to the measured reference capacitance would be obtained. Accordingly, the control module 4 determines that no material is in vicinity of the first sensor 3 (i.e., the level of the material is lower than the position of the detecting apparatus).

On the other hand, for the container 9 in FIG. 2 (where the level of the material is higher than the position of the detecting apparatus), the detecting operation performed by the first sensor 3 would obtain a capacitance higher than the measured reference capacitance. Accordingly, the control module 4 determines that there is material in vicinity of the first sensor 3 (i.e., that the level of the material is higher than the position of the detecting apparatus).

It is preferred that the first sensor 3 be disposed to extend along a horizontal axis in order to achieve better detecting accuracy. Moreover, the first sensor 3 is preferred to be made in an elongated shape with a minimal height to enhance the precision of the detecting apparatus in determining whether the level of the material in the container 9 is below or at/above the specific height.

In this embodiment, the container 9 is made by a non-metal material, and the substrate 2 is attached directly to an outer surface of the container 9. For example, the container 9 may be embodied using a plastic bottle containing drinking water, and the detecting apparatus is not able nor desirable to be disposed inside the container 9. In other embodiments, in cases where it is acceptable for the detecting apparatus to be disposed inside the container 9, the material of the container 9 is not limited to non-metal material.

The detecting apparatus in this embodiment may be used in a variety of applications. For example, the detecting apparatus may be used in an assembly line for producing bottled drinks. The detecting apparatus can be attached to a specific location of each of the bottles produced by the assembly line, and to automatically detect whether each of the bottles contains sufficient drink therein. In some embodiments, the detecting apparatus may include components for initiating other procedures in response to the determination made by the control module 4 (e.g., a capacitance equal to the measured reference capacitance indicates that the bottle contains insufficient drink, and a refill procedure may be required).

While in this embodiment the detecting apparatus is embodied using a capacitive sensor, in other embodiments the detecting apparatus may be configured to detect other electrical properties such as an electrical current, an electrical potential difference, an electrical resistance, etc.

In one embodiment, the first sensor 3 and the control module 4 are disposed on a same side surface of the substrate 2.

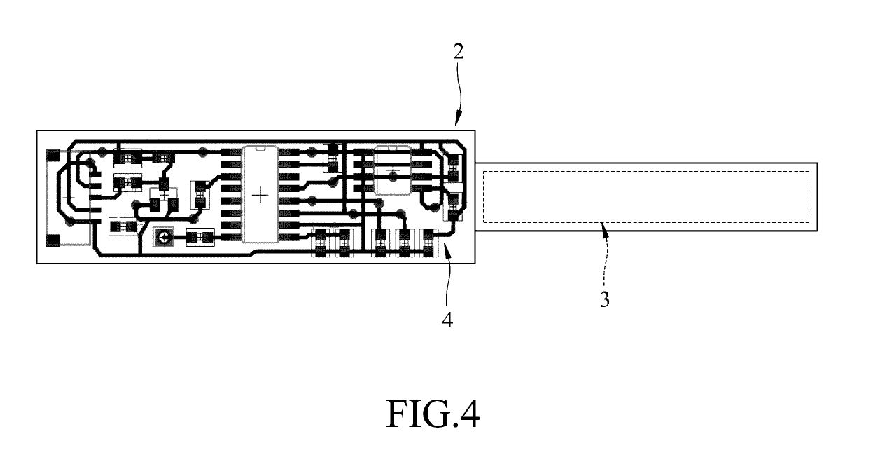

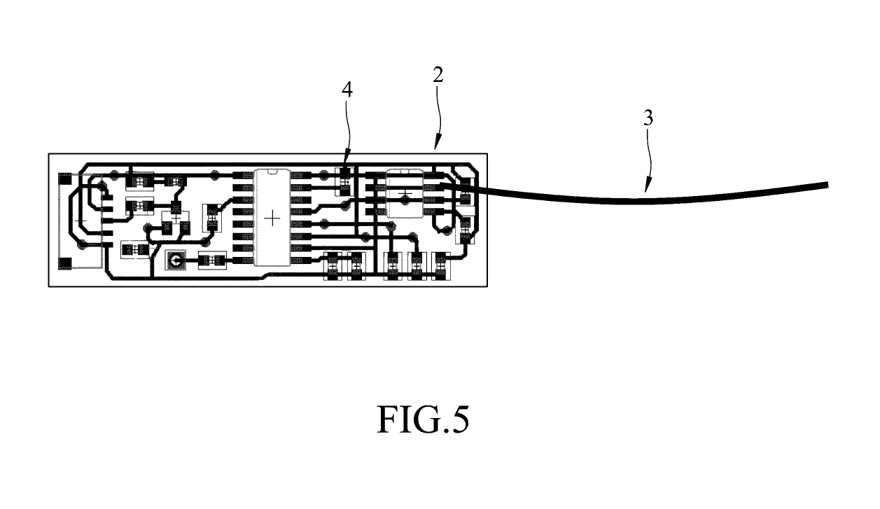

It is noted that a number of implementations may be applied to the material detecting system, according to the first embodiment. For example, the first sensor 3 may be aligned with the control module 4 along a vertical direction, as shown in FIG. 3, or along a horizontal direction, as shown in FIG. 4. In one implementation as shown in FIG. 5, the first sensor 3 includes an electrical wire and/or a bus wire extending along a horizontal direction.

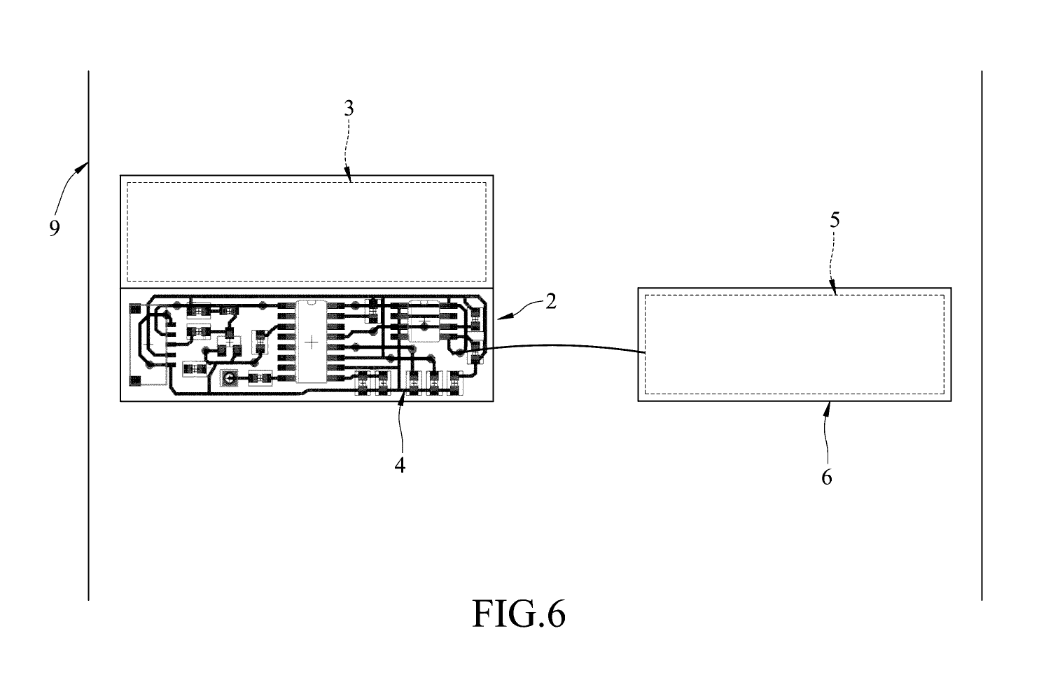

In one implementation as illustrated by FIG. 6, the detecting apparatus of the material detecting system further includes a second sensor 5 and a sensor board 6. The sensor board 6 is configured to be attached directly to the container 9. The second sensor 5 may be made to have a material and a shape that are similar to those of the first sensor 3.

As seen in FIG. 6, the second sensor 5 is coupled to the control module 4 (e.g., via an electrical wire), and is disposed on the sensor board 6 so as to be disposed at the container 9.

Similar to the previously described operation regarding the first sensor 3, the control module 4 is configured to transmit a second test signal to the second sensor 5 so as to enable the second sensor 5 to perform a detecting operation. The second sensor 5 is then controlled to generate a second response signal according to the detecting operation, and to transmit the second response signal to the control module 4. The control module 4 is then able to determine whether the container 9 contains the material in vicinity of a location where the second sensor 5 is disposed, based on the second response signal.

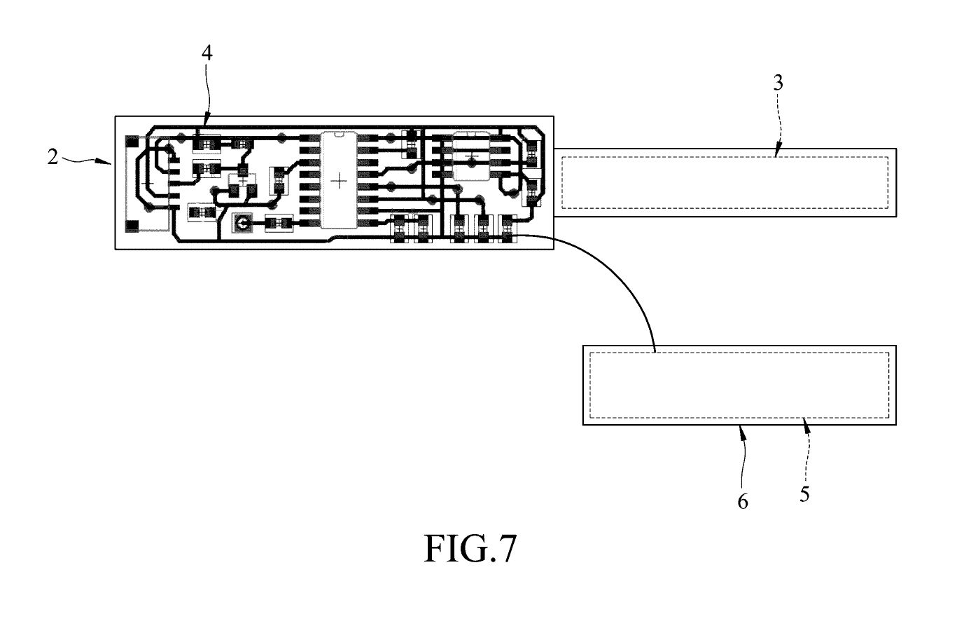

In practice, the first sensor 3 and the second sensor 5 may be disposed at different locations on the container 9. Specifically, the first sensor 3 and the second sensor 5 may be disposed at different heights from the bottom of the container 9 (one example is shown in FIG. 7).

The detecting apparatus is therefore able to determine whether the level of material is at/above or below both heights corresponding to positions of the first sensor 3 and the second sensor 5 on the container, or between the heights.

In one application, the second sensor 5 may be disposed at a location from the bottom of the container 9 that indicates a “warning” level. The first sensor 3 may be disposed at a location from the bottom of the container 9 that indicates an “emergency stop” level.

When it is determined that the level of the material is at/above the “warning” level but below the “emergency stop” level, the control module 4 may output a warning signal indicating that the level of the material is about to be too high. Subsequently, when it is determined that the level of the material is at or above the “emergency stop” level, the control module 4 may output a kill-switch signal indicating that the level of the material is too high.

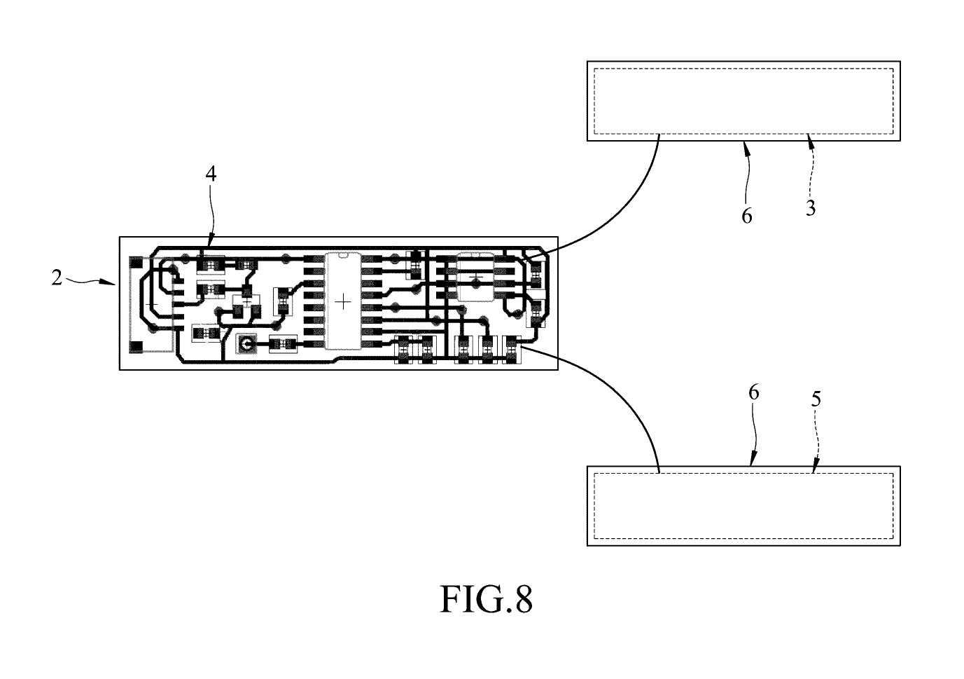

FIG. 8 illustrates an implementation that is similar to the implementation of FIGS. 6 and 7. The main difference between the implementation of FIG. 8 and the implementation of FIGS. 6 and 7 is that the detecting apparatus includes two sensor boards 6 each coupled to the control module 4 via an electrical wire. Only the control module 4 is disposed on the substrate 2, while the first sensor 3 and the second sensor 5 are disposed on the sensor boards 6, respectively.

In use, the sensor boards 6 may be embodied using either rigid boards or flexible boards, depending on the surface of the container 9 on which the sensor boards 6 are disposed. For example, when the surface of the container 9 is curved, flexible boards may be used to ensure that the sensor boards 6, and in turn the first sensor 3 and the second sensor 5, can be fittingly attached to the container 9 in order to achieve better detecting accuracy.

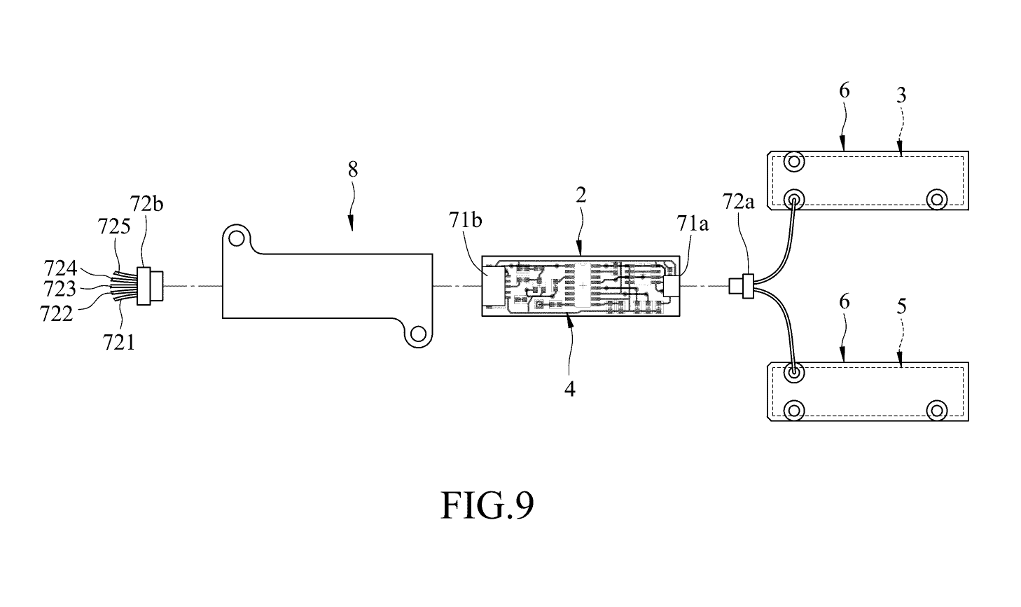

FIG. 9 illustrates an implementation that is similar to the implementation of FIG. 8. The main difference between the implementation of FIG. 9 and the implementation of FIG. 8 is that the detecting apparatus further includes two connection ports 71a and 71b, two connecting wire sets 72a and 72b, and a housing 8 that accommodates the substrate 2 and the control module 4.

The connection ports 71a and 71b are disposed on the substrate 2, and are coupled to the control module 4. The connecting wire set 72a interconnects the connection port 71a to the sensor boards 6, and is configured to transmit the first test signal and the second test signal from the control module respectively to the first sensor 3 and the second sensor 5 and the first response signal and the second response signal from the first sensor 3 and the second sensor 5, respectively, to the control module 4. The connecting wire set 72b interconnects the connection port 71b to an external system (not depicted in the drawings) for receiving additional commands therefrom and/or transmitting data to the external system via the connecting wire set 72b.

In this implementation, the detecting apparatus is controlled by the external system to perform the initiation process.

Specifically, the connecting wire set 72b includes five connecting wires 721 to 725, each of which is used for transmitting a specific signal, as summarized in the following Table 1.

TABLE 1

| Wire Number | Signal Labeling | Description |
|---|---|---|
| 721 | Low Voltage (Vss) | Negative supply |
| | | voltage |
| 722 | High Voltage | Positive supply |
| | (Vdd) | voltage |
| 723 | Signal 1 | First response |
| | | signal |
| 724 | Signal 2 | Second response |
| | | signal |
| 725 | Adjust | Input signal for |
| | | initiation |

The connecting wires 721 and 722 cooperate to transmit electrical power to the detecting apparatus. The connecting wires 723 and 724 are configured to transmit the first response signal and the second response signal to the external system. The connecting wire 725 is for transmitting an initiation signal to the control module 4 for controlling the same to perform the initiation process.

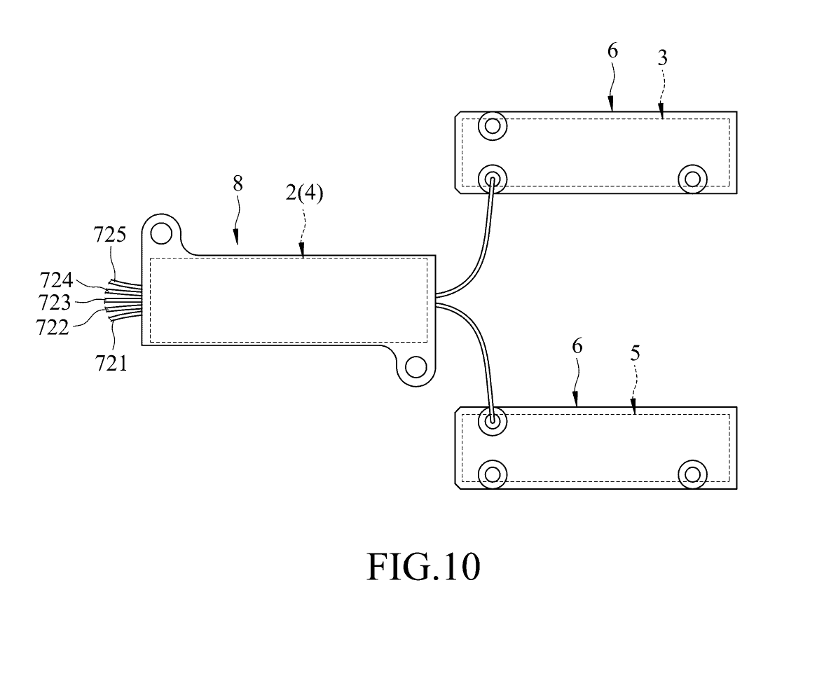

Further referring to FIG. 10, when the detecting apparatus is assembled, the housing 8 is for providing protection to the control module 4. In some embodiments, the housing 8 may be filled with an adhesive material (e.g., glue) for encapsulating the control module 4.

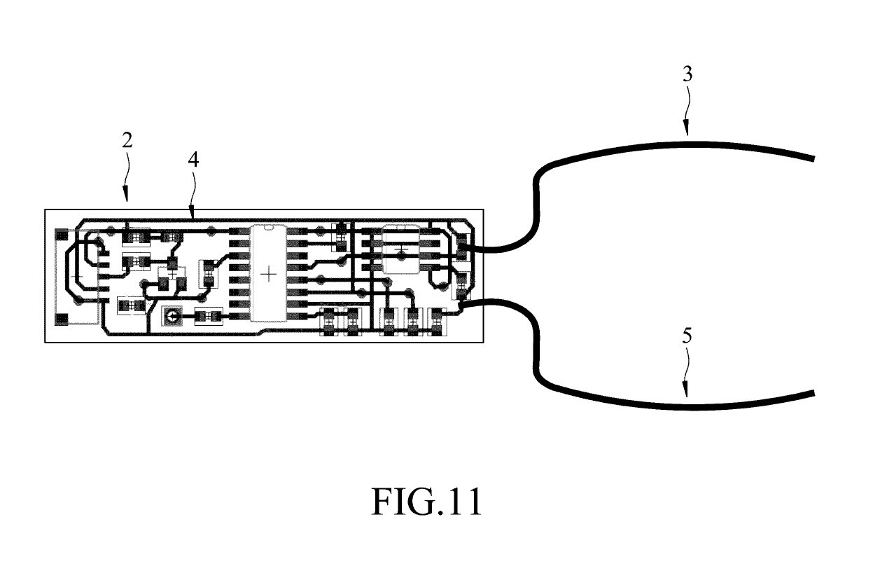

FIG. 11 illustrates an implementation that is similar to the implementation of FIG. 5. The main difference between the implementation of FIG. 11 and the implementation of FIG. 5 is that each of the first sensor 3 and the second sensor 5 of the implementation of FIG. 11 is embodied using an electrical wire.

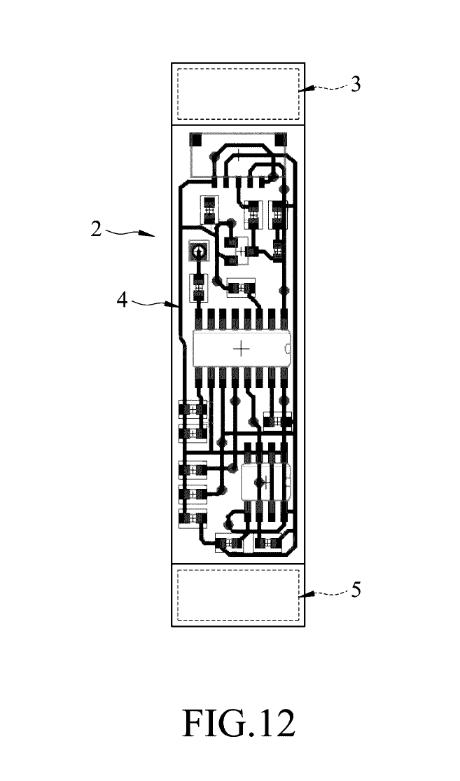

FIG. 12 illustrates a detecting apparatus of the material detecting system, according to a second embodiment of the disclosure.

In this embodiment, the first sensor 3 and the second sensor 5 are disposed on the substrate 2. Additionally, the substrate 2 has two opposite side surfaces and is configured to be attached directly to the container 9 (see FIG. 1). The sensor boards 6 are omitted in this embodiment. In other words, all components that constitute the detecting apparatus are integrated on the substrate 2.

The first sensor 3 and the second sensor 5 are disposed on one of the side surfaces of the substrate 2, and the control module 4 is disposed on the other one of the side surfaces of the substrate 2.

It is known that the first sensor 3 and the second sensor 5, both embodied as a capacitive sensor, are preferred to maintain a certain distance therebetween in order to reduce potential interference. That is to say, it may be desirable to place the first sensor 3 and the second sensor 5 apart from each other as much as possible. Accordingly, the first sensor 3 and the second sensor 5 may be disposed in a number of ways.

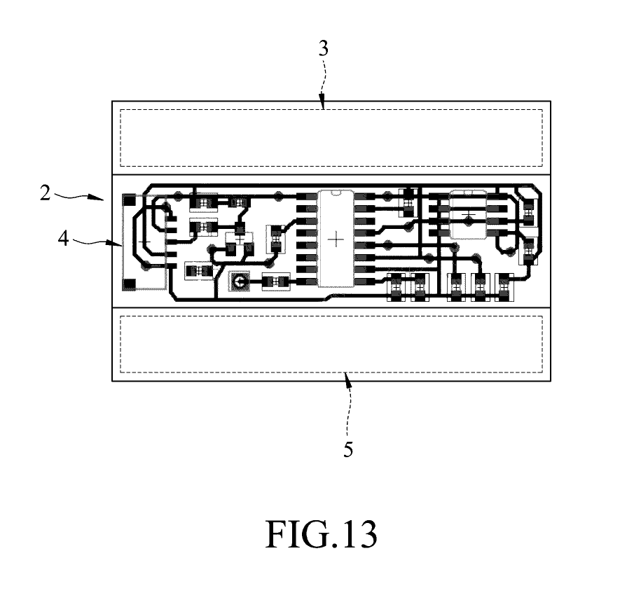

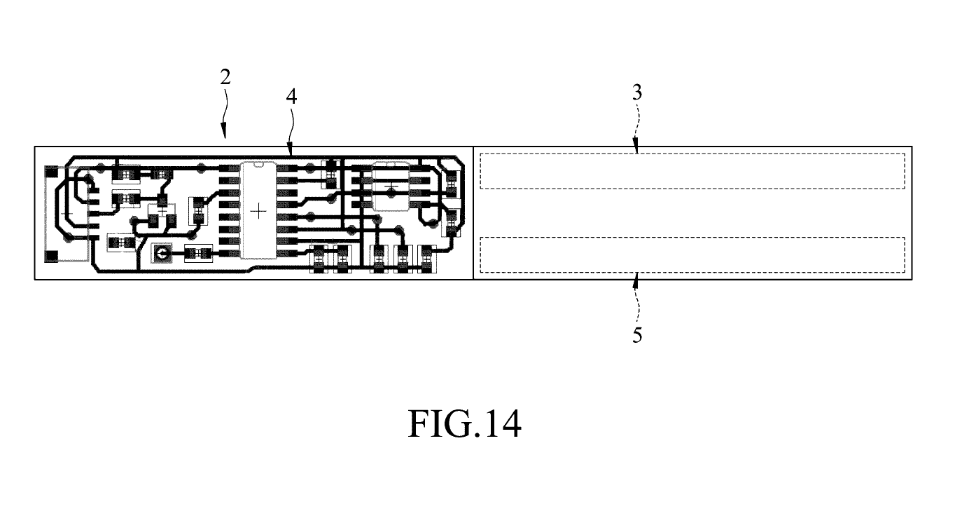

For example, in the implementation illustrated by FIG. 12, the control module 4 is made to have a rectangular shape, and the first sensor 3 and the second sensor 5 are disposed to correspond with the two short sides of the control module 4, respectively. In the implementation illustrated by FIG. 13, the first sensor 3 and the second sensor 5 are disposed to correspond with the two long sides of the control module 4. In the implementation illustrated by FIG. 14, the first sensor 3 and the second sensor 5 are disposed to correspond with an identical one of the sides of the control module 4 but kept apart from each other.

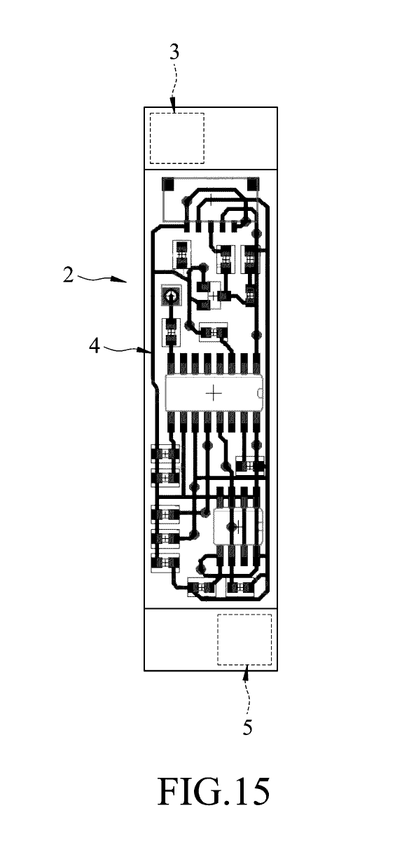

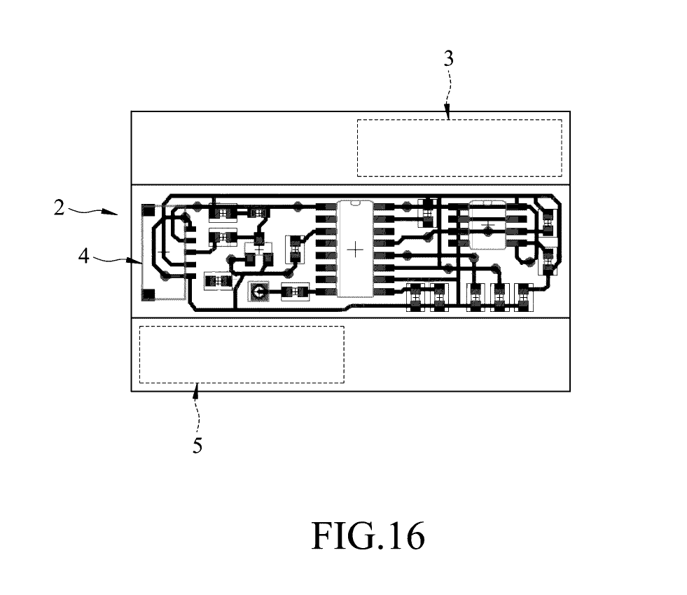

In the implementations illustrated by FIGS. 15 and 16, the first sensor 3 and the second sensor 5 are spaced apart two-dimensionally from each other (e.g., disposed to correspond with two vertexes connected by a diagonal).

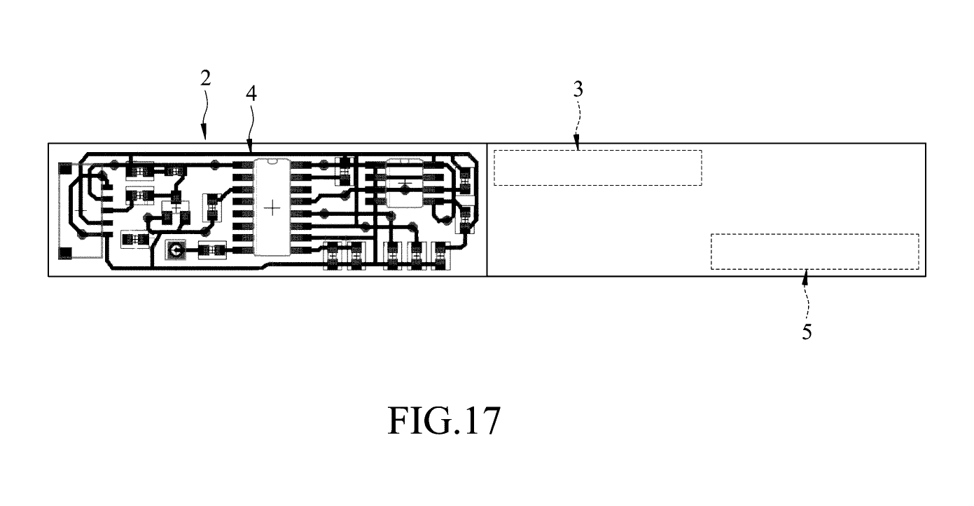

In the implementations illustrated by FIG. 17, the first sensor 3 and the second sensor 5 are disposed to correspond with an identical one of the sides of the control module 4, and are spaced apart two-dimensionally from each other.

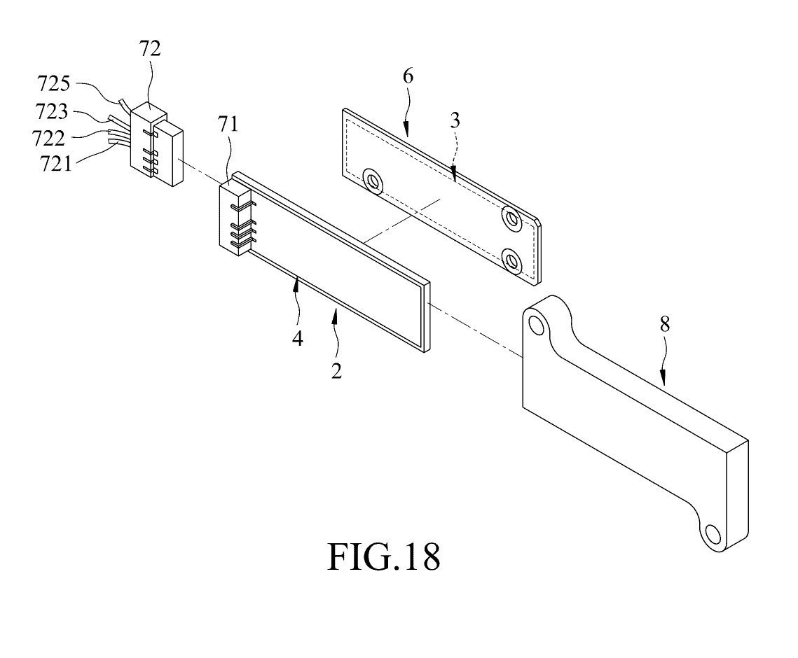

FIG. 18 illustrates a detecting apparatus of the material detecting system, according to a third embodiment of the disclosure. In this embodiment, the detecting apparatus includes one sensor board 6, a connection port 71, a connecting wire set 72 and a housing 8.

The sensor board 6 has a first side surface configured to be attached directly to the container 9 (see FIG. 1), and a second side surface opposite to the first side surface. The first sensor 3 is disposed on the first side surface, and the substrate 2 is attached to the second side surface. The housing 8 houses the substrate 2, the sensor board 6 and the control module 4.

The connection port 71 is coupled to the control module 4. The connecting wire set 72 interconnects the connection port 71 to the external system, and includes four connecting wires 721, 722, 723 and 725, each of which is used for transmitting a specific signal, as summarized in the following Table 2.

TABLE 2

| Wire Number | Signal Labeling | Description |
|---|---|---|
| 721 | Low Voltage (Vss) | Negative supply |
| | | voltage |
| 722 | High Voltage | Positive supply |
| | (Vdd) | voltage |
| 723 | Signal 1 | First response |
| | | signal |
| 725 | Adjust | Input signal for |
| | | initiation |

Operations regarding the connecting wire set 72 are similar to those described in the implementation of FIG. 9, and will be omitted herein for the sake of brevity.

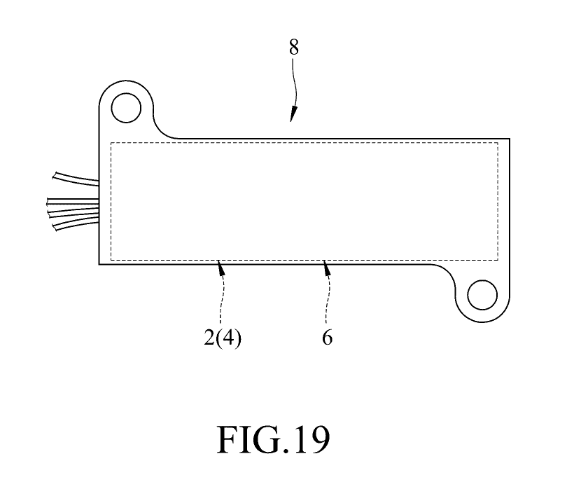

Further referring to FIG. 19, when the detecting apparatus is assembled, the housing 8 is for accommodating and providing protection to the control module 4. In some embodiments, the housing 8 may be filled with an adhesive material (e.g., glue) for encapsulating the control module 4.

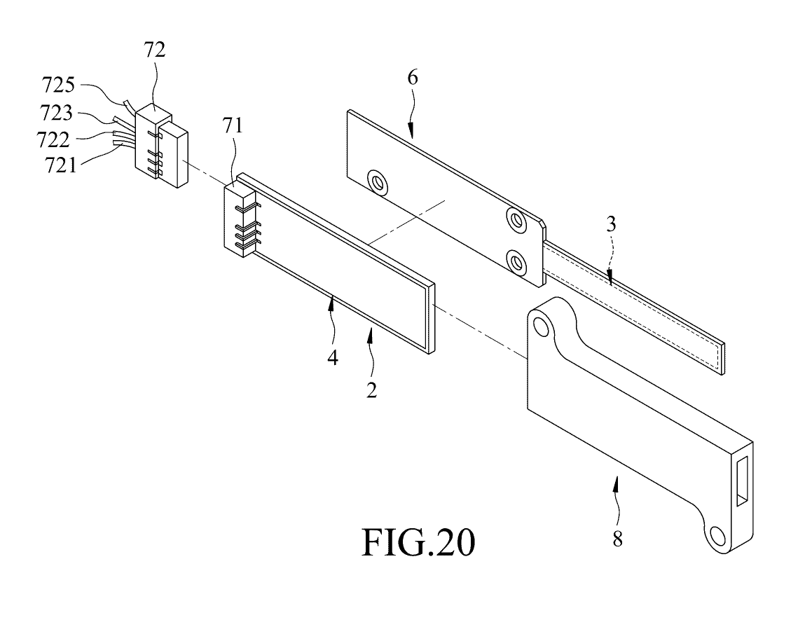

FIG. 20 illustrates an implementation that is similar to the implementation of FIG. 18. The main difference between the implementation of FIG. 20 and the implementation of FIG. 18 is that the first sensor 3 of the implementation of FIG. 20 is disposed on an extended part of the sensor board 6, which is connected to the substrate 2 side by side and has a side surface. The control module 4 is disposed on one of the side surfaces of the substrate 2, and the first sensor 3 is disposed on the side surface of the sensor board 6.

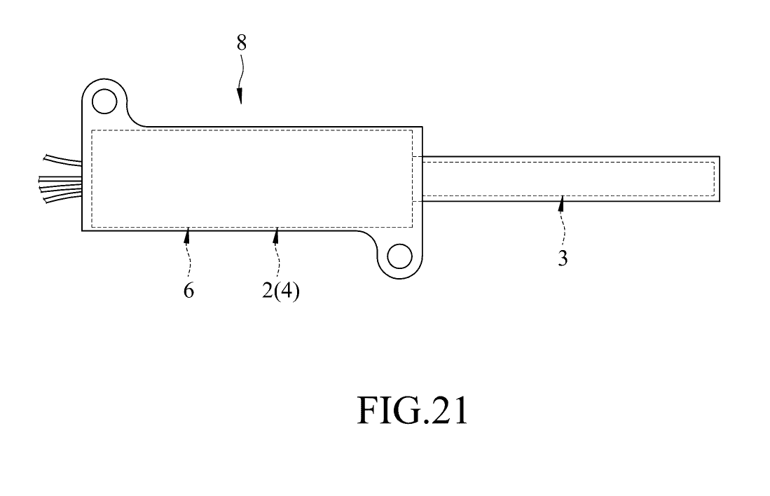

Further referring to FIG. 21, when the housing 8 accommodates the control module 4, the extended part of the sensor board 6 and the first sensor 3 extends outwardly from the housing 8. In other embodiments, the extended part of the sensor board 6 and the first sensor 3 may extend along various directions.

It is noted that a width of the first sensor 3 may be made smaller than that of the substrate 2 for achieving better detecting precision.

In one embodiment, the detecting apparatus may be used for detecting a plurality of containers 9 that are being carried by, for example, a conveyor belt (i.e., the containers 9 are movable with respect to the first sensor 3). In this embodiment, the detecting apparatus may be placed near the conveyor belt, and when one of the containers 9 is carried near the detecting apparatus, the first sensor 3 may be attached to the surface of the one of the containers 9, allowing a detecting operation to be performed for the one of the containers 9. When it is determined, for the one of the containers 9, that the level of the material (e.g., a beverage) is below the location of the detecting apparatus, a warning signal may be generated for alerting the personnel operating the conveyor belt.

To sum up, the material detecting system and the detecting apparatus thereof as described in the disclosure have the following effects:

1. The detecting apparatus employs a capacitive sensor to detect the material, thereby omitting the conventionally employed mechanical structures, which may not operate properly due to the presence of foreign substances such as limescale.

2. The detecting apparatus may be placed on the outer surface of the container 9, and is able to perform the detecting operation without being in direct physical contact with the material. This may be beneficial in cases where contact between the material and the detecting apparatus is undesirable. In cases where the detecting apparatus is disposed inside the container 9, the provision of the housing 8 prevents contamination of the material in the container 9 from at least the control module 4.

3. The detecting apparatus may include one or more additional sensors for simultaneously providing detecting operations on multiple levels, and therefore is able to provide more versatility.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An apparatus for detecting a material in a container, said apparatus comprising:
a first sensor configured to be disposed at the container; and
a control module coupled to said first sensor, and configured to
transmit a first test signal to said first sensor so as to enable said first sensor to perform a detecting operation, to generate a first response signal according to the detecting operation, and to transmit the first response signal to said control module, and
determine whether the container contains the material in vicinity of a location where said first sensor is disposed.

2. The apparatus of claim 1, further comprising a second sensor coupled to said control module and configured to be disposed at the container, wherein said control module is further configured to:
transmit a second test signal to said second sensor so as to enable said second sensor to perform a detecting operation and to generate a second response signal according to the detecting operation, and to transmit the second response signal to said control module; and
determine whether the container contains the material in vicinity of a location where said second sensor is disposed.

3. The apparatus of claim 2, further comprising a substrate configured to be attached directly to the container,
wherein said first sensor and said second sensor are disposed on a side surface of said substrate, and are spaced apart two-dimensionally from each other.

4. The apparatus of claim 2, further comprising a substrate having two opposite side surfaces and configured to be attached directly to the container,
wherein said first sensor and said second sensor are disposed on one of said side surfaces of said substrate, and said control module is disposed on the other one of said side surfaces of said substrate.

5. The apparatus of claim 2, further comprising a substrate, and two sensor boards configured to be attached directly to the container,
wherein said control module is disposed on said substrate, and said first sensor and said second sensor are disposed on said sensor boards, respectively.

6. The apparatus of claim 1, further comprising a substrate, and a sensor board configured to be attached directly to the container,
wherein said control module is disposed on said substrate, and said first sensor is disposed on said sensor board.

7. The apparatus of claim 6, wherein said sensor board has a first side surface configured to be attached directly to the container, and a second side surface opposite to said first side surface,
wherein said first sensor is disposed on said first side surface, and said substrate is attached to said second side surface.

8. The apparatus of claim 1, further comprising a substrate having two opposite side surfaces and configured to be attached directly to the container,
wherein said first sensor is disposed on one of said side surfaces of said substrate, and said control module is disposed on the other one of said side surfaces of said substrate.

9. The apparatus of claim 1, further comprising a substrate configured to be attached directly to the container,
wherein said first sensor and said control module are disposed on a same side surface of said substrate.

10. The apparatus of claim 1, further comprising a substrate that has a side surface, and a sensor board that is connected to said substrate side by side and that has a side surface,
wherein said control module is disposed on said side surface of said substrate, and said first sensor is disposed on said side surface of said sensor board.

11. The apparatus of claim 1, wherein said first sensor is one of an electrical wire and a metal plate.

12. The apparatus of claim 1, wherein said control module and said first sensor cooperate to serve as a capacitive sensor.

13. The apparatus of claim 1, further comprising a housing that accommodates said control module.

14. A material detecting system comprising:
a container for containing a material;
a detecting apparatus configured for detecting the material in said container, and including a first sensor that is disposed at said container, and a control module that is coupled to said first sensor and that is configured to
transmit a first test signal to said first sensor so as to enable said first sensor to perform a detecting operation, to generate a first response signal according to the detecting operation, and to transmit the first response signal to said control module, and
determine whether said container contains the material in vicinity of a location where said first sensor is disposed.

15. The material detecting system of claim 14, wherein said detecting apparatus further includes a second sensor coupled to said control module and configured to be disposed at said container,
wherein said control module is further configured to:
transmit a second test signal to said second sensor so as to enable said second sensor to perform a detecting operation and to generate a second response signal according to the detecting operation, and to transmit the second response signal to said control module, and
determine whether said container contains the material in vicinity of a location where said second sensor is disposed.

16. The material detecting system of claim 15, wherein said first sensor and said second sensor are disposed at different locations on said container.

17. The material detecting system of claim 16, wherein said container includes a bottom, and said first sensor and said second sensor are disposed at different heights from said bottom.

18. The material detecting system of claim 15, wherein said first sensor is one of an electrical wire and a metal plate.

19. The material detecting system of claim 15, wherein said control module and said first sensor cooperate to serve as a capacitive sensor.

20. The material detecting system of claim 15, wherein said container is movable with respect to said first sensor.
